(19) United States
(12) Patent Application Publication
(10) Pub. No.: US 2009/0090072 A1
(43) Pub. Date: Apr. 9, 2009

(54) Window Assembly with built-in exterior shield

(76) Inventor: Tommy To, Los Angeles, CA (US)

Correspondence Address: Tommy To, P.O. Box 1818, Rancho Cucamonga, CA, 91729-1818, US

(21) Appl. No.: 11/867,185

(22) Filed: Oct. 4, 2007

(51) Int. Cl. E06B 3/00

(52) U.S. Cl. 52/202

(57) ABSTRACT

A exterior shield includes a retraction arrangement coupling with a sheet-like shield element to wind the shield element as a coil within a housing the exterior shield comprises a retraction arrangement coupling with a sheet-like shield element to wind the shield element as a coil within a housing and an operation system which comprises an actuation unit provided at an interior side of the window frame. The actuation unit is actuated at the interior side of the window frame to downwardly pull the bottom edge portion of the shield element so that the shield element is extended to enclose the window panel at the exterior side thereof. When the bottom edge portion of the shield element is moved upwardly to the top rim, the shield element is wounded in the housing.

### BACKGROUND

1. Field of the Invention

The present invention relates to a window assembly. More particularly, the window assembly comprises a built-in exterior shield which can be operated at the interior side of the window assembly, wherein the exterior shield is arranged to be extended as a sheet to protect the window panel at the exterior side of the window assembly and to be wound as a coil within the housing.

2. Discussion of the Related Art

Storm damage caused billions of dollars in property damage. Especially, flying debris and water crashing through the windows will cause seriously damage inside the structure during the storm.

Generally speaking, the homeowners will put the boards outside the homes to cover the windows during a coming storm. Then, they have to remove the boards after the storm. It is dangerous for the homeowners to nail the boards at the exterior wall of the house when the storm has come. In addition, the nail will also damage the exterior wall of the house.

Putting the boards inside the house to cover the windows can be a safe way for the homeowners during the coming storm. However, the flying debris may break the glass window. Therefore, most homeowners prefer the exterior shield to prevent the glass window from being broken.

However, the exterior shield has a common disadvantage that the homeowners must go out of the house to raise or lower the shields over the windows. It is worth mentioning that it is dangerous for the homeowners to go out of the house when the storm has come. In addition, it is impossible to raise or lower the shields over the windows at the highrise multistory building.

### BRIEF SUMMARY OF THE INVENTION

The present invention overcomes the above mentioned drawbacks and limitation by providing a shield at the exterior side of a structure opening and controlling the shield at the interior side of the structure opening.

The primary objective of the present invention is to provide an exterior shield for protecting structure openings such as windows and doors. More particularly, the shield is operated at the interior side of the structure opening. Therefore, the user is able to stay inside the house to operate the shield.

The second objective of the present invention is to provide the exterior shield in which the shield can be extended as a sheet to protect the window panel or the door panel at the exterior side thereof and can be wound as a coil to hide the coiled shield. Therefore, the shield is hidden out of sight when not in use.

The third objective of the present invention is to provide the exterior shield in which the window or the door can be normally operated when the shield is wound.

The fourth objective of the present invention is to provide the exterior shield in which the peripheral edge portion of the exterior shield is embedded in the window frame or the door frame so that the glass window panel or the door panel can be entirely covered and protected by the shield. Therefore, the shield is adapted for protection from storm damage and as a security device.

The fifth objective of the present invention is to provide the exterior shield in which any type of window panel or door panel can be incorporated with the shield without altering the original structure of the window assembly or the door assembly. Therefore, the shield can be incorporated with the sliding type window/door panel or pivot type window/door panel.

The sixth objective of the present invention is to provide the exterior shield which is perfectly used in highrise multistory building.

In accordance with the above important aspects of the present invention, the exterior shield comprises a retraction arrangement coupling with a sheet-like shield element to wind the shield element as a coil within a housing and an operation system which comprises an actuation unit provided at an interior side of the window frame. The actuation unit is actuated at the interior side of the window frame to downwardly pull the bottom edge portion of the shield element so that the shield element is extended to enclose the window panel at the exterior side thereof. When the bottom edge portion of the shield element is moved upwardly, the shield element is wounded in the housing.

For a more complete understanding of the present invention with its objectives and distinctive features and advantages, reference is now made to the following specification and to the accompanying drawings.

### BRIEF DESCRIPTION OF THE DRAWING(S)

FIG. 1 is a perspective view of the window assembly in accordance with the present invention.

FIG. 2 is a schematic view of the window assembly in accordance with the present invention.

FIG. 3 is a sectional view of the window assembly in accordance with the present invention, wherein the shield element is folded at the folded position.

FIG. 4 is a sectional view of the window assembly in accordance with the present invention, wherein the shield element is pulled at the unfolded position.

FIG. 5 is a perspective view of the alternative operation system of the window assembly in accordance with the present invention.

FIG. 6 is a schematic view of the alternative operation system of the window assembly in accordance with the present invention.

### DETAILED DESCRIPTION OF THE INVENTION

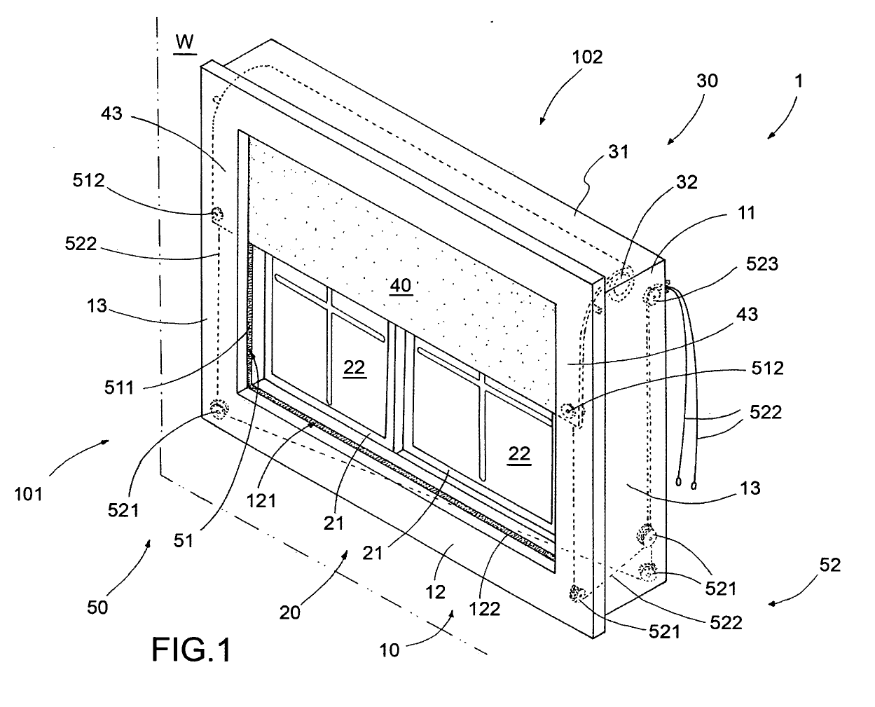

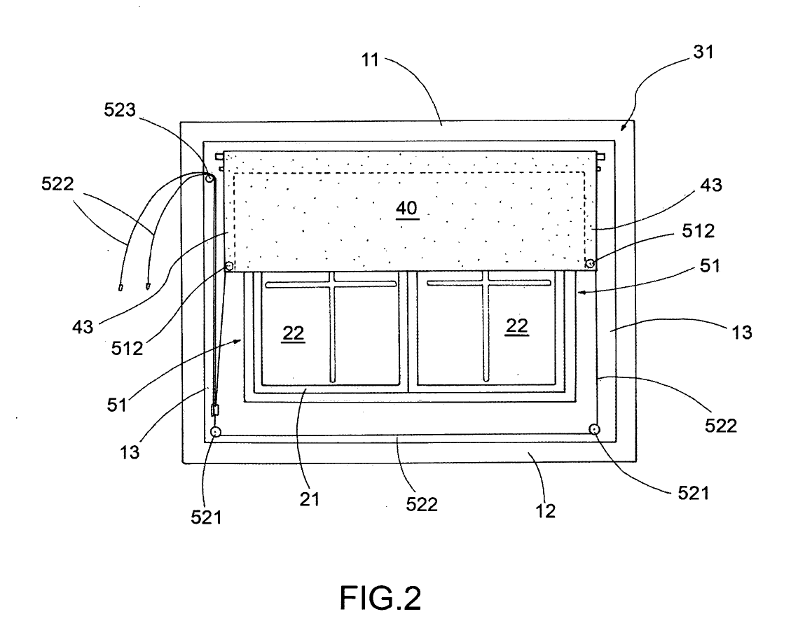

Referring to FIGS. 1 and 2, a window assembly in accordance with the present invention is illustrated. FIGS. 1 and 2 show the first embodiment of the window assembly. The window assembly comprises a window frame 1 defining an exterior side 101 and an interior side 102, and a window shield 2.

The window frame 1 comprises a mounting frame 10 for mounting at a wall structure W and a window panel 20 being mounted within the mounting frame 10 to define the interior side 102 at the inner side of the wall structure W and the exterior side 101 at outer side of the wall structure W.

FIG. 1 shows the mounting frame 10 having a rectangular shape and comprises a top rim 11, a bottom rim 12 and two side rims 13 to form a rectangular opening within the top rim 11, the bottom rim 12, and the side rims 13. The bottom rim 12 has an elongated sealing slot 121. Each of the top rim 11, the bottom rim 12, and the side rims 13 has a general U-shaped cross section.

FIG. 1 also shows the window panel 20 comprising a glass frame 21 and a glass panel 22 mounted thereto. The window panel 20 is mounted within the opening of the mounting frame 10 and is supported by the top rim 11, the bottom rim 12, and the side rims 13. The user is able to open the window frame 1 by sidewardly sliding the window panel 20 within the opening of the mounting frame 10, by upwardly sliding the window panel 20 within the opening of the mounting frame 10, by downwardly sliding the window panel 20 within the opening of the mounting frame 10, or by pivotally folding the window panel 20 within the opening of the mounting frame 10. Likewise, the window panel 20 can be permanently mounted within the opening of the mounting frame 10.

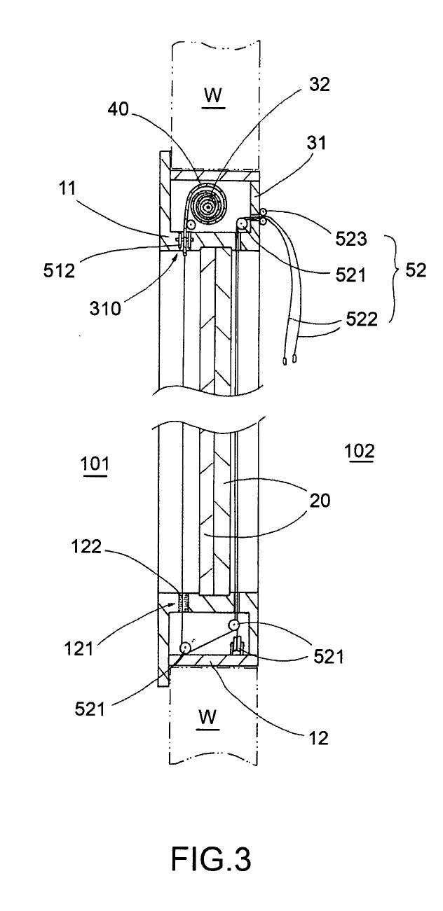

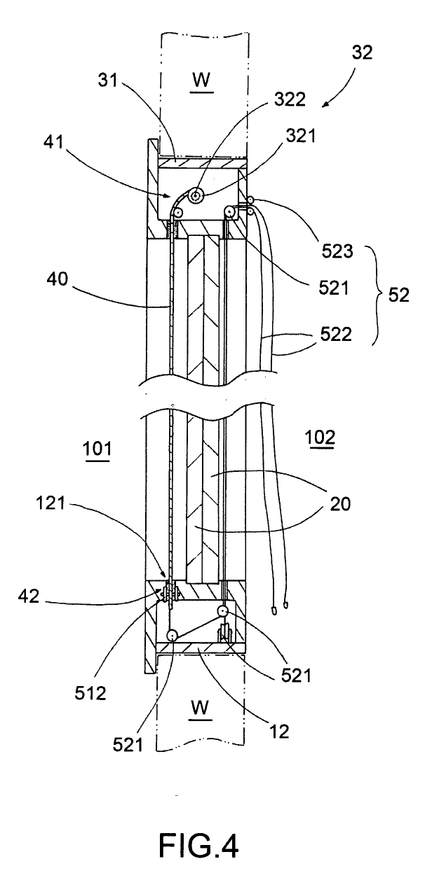

FIGS. 2 to 4 show the window shield 2 comprising a retraction arrangement 30, a sheet-like shield element 40, and an operation system 50 actuating the shield element 40 between a folded position and an unfolded position.

The retraction arrangement 30 comprises a housing 31 affixed to the top rim 11 and a retraction unit 32 supported in the housing 31. The housing 31 has an elongated opening 310 located at the exterior side 101 of the window frame 1 and aligned with the sealing slot 121 of the bottom rim 12.

The shield element 40, which is made of flexible material, has a size big enough to cover the window panel 20. It is preferred that the shield element 40 is made of rigid and corrosion-free metal, such as aluminum, so that the shield element 40 forms a window gate at the exterior side 101 of the window frame 1 to protect the window panel 20. Therefore, the user is able to operate the shield element 40 inside the building to form the exterior shield to protect the window panel 20.

The shield element 40 has a top edge portion 41 secured to the retraction unit 32 to be wound as a coil inside the housing 31, i.e. the folded position of the shield element 40. The shield element 40 further has a bottom edge portion 42 which is stopped at the opening 310 of the housing 31 and is pulled to the bottom rim 12 to be extended as a sheet to enclose the window panel 20, i.e. the unfolded position of the shield element 40. When the shield element 40 is extended as a sheet, the bottom edge portion 43 of the shield element 40 is received at the sealing slot 121 of the bottom rim 12. A sealing strap 122 is provided along the sealing slot 121 of the bottom rim 12 so that the bottom edge portion 43 of the shield element 40 is sealed and received at the sealing slot 121 via the sealing strap 122 when the bottom edge portion 42 of the shield element 40 is extended to cover the window panel 20 at the exterior side 101 thereof.

The shield element 40 further has two side edge portions 43 slidably mounted at the side rims 13 respectively. Therefore, when the shield element 40 is extended as a sheet to cover the window panel 20, the top edge portion 41, the bottom edge portion 42 and the side edge portions 43 of the shield element 40 are embedded in the top rim 11, the bottom rim 12 and the side rims 13 of the mounting frame 10 respectively. Having the above mentioned configuration, the strength of the shield element 40 can be enhanced to protect the window panel 20.

The shield element 40 also has two aesthetic films coated at two opposed surfaces so that the aesthetic films are adapted to be seen at both of the exterior and interior sides 101, 102 of the window frame 1 when the shield element 40 is extended to cover the window panel 20.

The housing 31 is supported by the top rim 11 of the mounting frame 10 and is hidden within the wall structure W. The opening 310 is formed at the top rim 11 so that the bottom edge portion 42 of the shield element 40 is slid through the top rim 11 at the opening 310 to the sealing slot 121 of the bottom rim 12. Preferably, the housing 31 is integrated with the top rim 11 of the mounting frame 10 so that the shield element 40 is wound and received in the top rim 11.

The retraction unit 32 comprises a retraction coil spring 321 mounted in the housing 31 and attached to the top edge portion 41 of the shield element 40 and a spring locker 322 selectively engaged with the retraction coil spring 321 to retain the shield element 40 in position. When a downward pulling force is applied at the bottom edge portion 42 of the shield element 40, the spring locker 322 is disengaged with the retraction coil spring 321 so that the shield element 40 is pulled to form the sheet structure. When the downward pulling force is released at the bottom edge portion 42 of the shield element 40, the spring locker 322 is automatically engaged with the retraction coil spring 321 to lock up the shield element 40. In order to retract the shield element 40 back to the housing 31, a mild downward pulling force is applied at the bottom edge portion 42 of the shield element 40 to release the engagement between the spring locker 322 and the retraction coil spring 321 so that the retraction coil spring 321 will apply the retraction force against the shield element 40 to wind up the shield element 40 in the housing 31.

The operation system 50 comprises two running rails 51 formed along the two side rims 13 of the mounting frame 10 for the two side edge portions 43 of the shield element 40 sliding at the running rails 51 respectively and an actuation unit 52 provided at the interior side 102 of the window frame 1. The actuation unit 52 is actuated at the interior side 102 of the window frame 1 to downwardly pull the bottom edge portion 42 of the shield element 40 so that the shield element 40 is extended to enclose the window panel 20 at the exterior side 101 thereof, wherein when the bottom edge portion 42 of the shield element 40 is moved upwardly to the top rim 11, the shield element 40 is wounded in the housing 31.

Two weather straps 511 are mounted along the running rails 51 for the side edge portions 43 of the shield element 40 to slide along the running rails 51 respectively to water-seal the shield element 40 at the side rims 13.

Two or more roller wheels 512 are rotatably affixed to the side edge portions 43 of the shield element 40 to slide along the running rails 51 respectively for enhancing the sliding movement of the shield element 40. When the bottom edge portion 42 of the shield element 40 is pulled downwardly, the roller wheels 512 rotates and drives the side edge portions 43 of the shield element 40 to slide along the running rails 51 respectively until the bottom edge portion 42 of the shield element 40 receives at the sealing slot 121 of the bottom rim 12. When the shield element 40 is retracted, the roller wheels 512 also rotates and drives the side edge portions 43 of the shield element 40 to slide along the running rails 51 respectively until the bottom edge portion 42 of the shield element 40 stays at the opening 310 of the housing 31 at the top rim 11.

FIG. 2 shows the actuation unit 52 comprising a plurality of spaced apart pulleys 521 rotatably supported at the bottom rim 12 and a pulling cable 522 having a hidden portion affixing to the bottom edge portion 42 of the shield element 40 and a pulling portion extended to couple with the pulleys 521 and extended out of the window frame 1 at the interior side 102 thereof, so that when the pulling portion of the pulling cable 522 is pulled downwardly, the bottom edge portion 42 of the shield element 40 is pulled downwardly to the bottom rim 12 through the pulleys 521.

The pulleys 521 are mounted below the bottom rim 12 of the mounting frame 10 within the wall structure W, wherein the pulleys 521 are used to transmit the downward pulling force at the pulling cable 522 into the downward pulling force at the bottom edge portion 42 of the shield element 40.

The pulling cable 522 has two pulling ends affixed to the bottom edge portion 42 of the shield element 40 within the side edge portions 43 thereof, i.e. the corner portions of the shield element 40. Therefore, the hidden portion of the pulling cable 522 runs within the side rims 13 to the bottom rim 12 to keep the hidden portion of the pulling cable 522 within the mounting frame 10 in an out of sight manner. A cable pulley 523 is rotated and mounted at the top rim 11 of the mounting frame 10 close to one of the side rims 13 thereof, wherein the pulling portion of the pulling cable 522 is extended out of the mounting frame 10 at the interior side 102 thereof to engage with the cable pulley 523. Therefore, when the downward pulling force is applied at the pulling portion of the pulling cable 522, the cable pulley 523 and the pulleys 521 are correspondingly rotated to transmit the downward pulling force at the pulling portion of the pulling cable 522 into the downward pulling force at the bottom edge portion 42 of the shield element 40. When the mild downward pulling force is applied at the pulling portion of the pulling cable 522, the spring locker 322 is disengaged with the retraction coil spring 321 to retract the shield element 40.

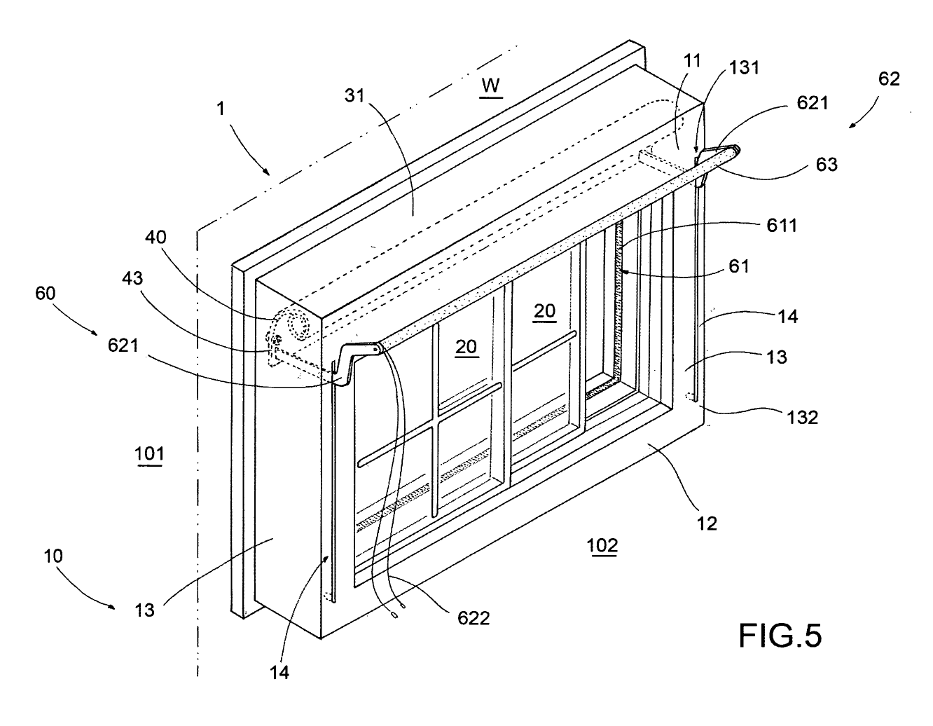

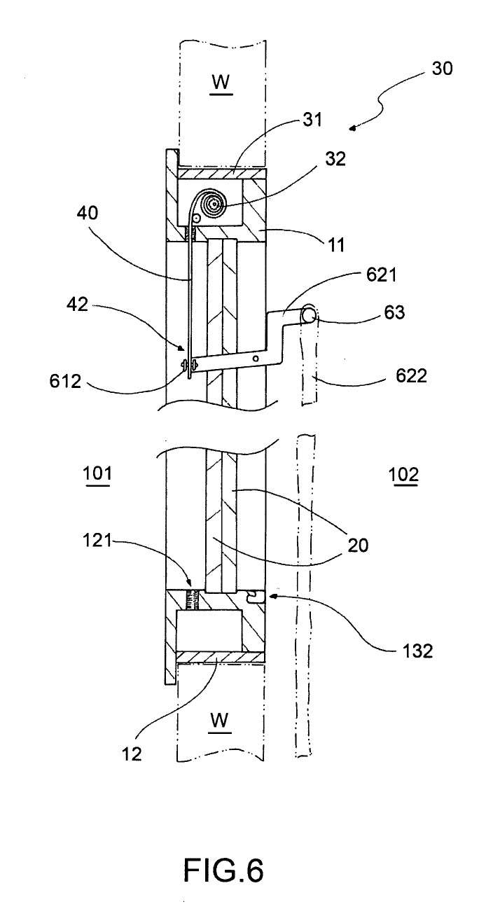

FIGS. 5 and 6 show another embodiment of the operation system 60 the window assembly. The operation system 60 comprises two running rails 61 formed along the two side rims 13 of the mounting frame 10 for the two side edge portions 43 of the shield element 40 sliding at the running rails 61 respectively and an actuation unit 62 provided at the interior side 102 of the window frame 1. The actuation unit 62 is actuated at the interior side 102 of the window frame 1 to downwardly pull the bottom edge portion 42 of the shield element 40 so that the shield element 40 is extended to enclose the window panel 20 at the exterior side 101 thereof, wherein when the bottom edge portion 42 of the shield element 40 is moved upwardly to the top rim 11, the shield element 40 is wounded in the housing 31.

The mounting frame 10 further has two elongated guiding rails 14 provided at the two side rims 13 respectively at the interior side 102 thereof, wherein each of the guiding rails 14 is extended from the top rim 11 of the mounting frame 10 to the bottom rim 12 thereof.

Two weather straps 611 are mounted along the running rails 61 for the side edge portions 43 of the shield element 40 to slide along the running rails 61 respectively to water-seal the shield element 40 at the side rims 13.

The actuation unit 62 comprises two sliding members 621 extended from the bottom edge portion 42 of the shield element 40. The free ends of the sliding members 621 are extended at the interior side 102 of the window frame 1 through the guiding rails 14 respectively. Therefore, when the two free ends of the sliding members 621 are pulled at the interior side 102 of the window frame 1 to downwardly slide the bottom edge portion 42 of the shield element 40, the shield element 40 is extended to enclose the window panel 20.

As it is mentioned in the first embodiment, the side edge portions 43 of the shield element 40 are embedded in the side rims 13 of the mounting frame 10 respectively. The sliding members 621 are affixed to the two corner portions of the shield element 40 and extended out of the side rims 13 through the guiding rails 14 respectively. Therefore, when the free ends of the sliding members 621 are pulled downwardly along the guiding rails 14, the bottom edge portion 42 of the shield element 40 will be pulled downwardly.

Two or more roller wheels 612 are rotatably affixed to the side edge portions 43 of the shield element 40 to slide along the running rails 61 respectively for enhancing the sliding movement of the shield element 40. When the bottom edge portion 42 of the shield element 40 is pulled downwardly, the roller wheels 612 rotates and drives the side edge portions 43 of the shield element 40 to slide along the running rails 61 respectively until the bottom edge portion 42 of the shield element 40 receives at the sealing slot 121 of the bottom rim 12. When the shield element 40 is retracted, the roller wheels 612 also rotates and drives the side edge portions 43 of the shield element 40 to slide along the running rails 61 respectively until the bottom edge portion 42 of the shield element 40 stays at the opening 310 of the housing 31 at the top rim 11.

The operation system 60 further comprises an elongated curtain shaft 63 detachably coupling with the free ends of the sliding members 621 to drive the sliding members 621 sliding towards the bottom rim 12, when the shield element 40 is wounded in the housing 31, the curtain shaft 63 is moved at the top rim 11 for a curtain being supported at the interior side 102 of the window frame 1. Therefore, the curtain shaft 63 is used as a supporting rod to hang the curtain when the shield element 40 is at the folded position and is used as an operation rod to pull the shield element 40 from the folded position to the unfolded position.

If the window frame 1 is big enough that the user cannot reach the curtain shaft 63 to pull down the shield element 40, a pulling cable 622 is affixed to the curtain shaft 63. Therefore, the user can pull down the curtain shaft 63 via the pulling cable 622.

Each of the side rims 13 has a top stopper 131 and a bottom stopper 132. The top and bottom stoppers 131, 132 are formed adjacent to the top and bottom rims 11, 12 respectively. The sliding members 621 are upwardly slid until the sliding members 621 are blocked at the top stoppers 131 respectively when the shield element 40 is wound in the housing 31. The sliding members 621 are downwardly slid until the sliding members 621 are blocked at the bottom stoppers 132 when the shield element 40 is extended to cover the window panel 20. Therefore, the top stoppers 131 can hold the shield element 40 at the unfolded position and the bottom stoppers 132 can hold the shield element 40 at the folded position. The top stopper 131 is formed at the top end of each of the guiding rails 14 and the bottom stopper 132 is formed at the bottom end of each of the guiding rails 14.

If the shield element 40 is made of light filtering material that the shield element 40 forms a window shade at the exterior side 101 of the window frame 1 to shade the window panel 20, a plurality of intermediate stoppers is formed at each of the side rims 13 between the top and bottom stopper 131, 132. Therefore, the window shade of the shield element 40 can be selected to stop at the intermediate stoppers to partially block the light through the window panel 20. If the shield element is made of rigid and corrosion-free metal, only two sets of top and bottom stoppers 131, 132 should be enough to hold the shield element 40 at the above mentioned positions.

While the embodiments and alternatives of the present invention have been shown and described, it will be apparent to one skilled in the art that various other changes and modifications can be made without departing from the spirit and scope of the present invention.

What is claimed is:

1. A window assembly, comprising:
a window frame comprising a mounting frame for mounting at a wall structure and a window panel being mounted within said mounting frame to define an interior side and an exterior side, said mounting frame having a rectangular shape and comprising a top rim, a bottom rim and two side rims; and
a window shield, comprising:
a retraction arrangement which comprises a housing affixed to said top rim and a retraction unit supported in said housing, said housing having an opening located at said exterior side of said window frame;
a sheet of shield element, which is made of flexible material, having a size big enough to cover said window panel, wherein said shield element has a top edge portion secured to said retraction unit to be wound as a coil inside said housing and a bottom edge portion which is stopped at said opening of said housing and is pulled to said bottom rim to be extended as a sheet to enclose said window panel; and
an operation system which comprises two running rails formed along said two side rims of said mounting frame for two side edge portions of said shield element sliding at said running rails respectively and an actuation unit provided at said interior side of said window frame, wherein said actuation unit is actuated at said interior side of said window frame to downwardly pull said bottom edge portion of said shield element so that said shield element is extended to enclose said window panel at said exterior side thereof, wherein when said bottom edge portion of said shield element is moved upwardly to said top rim, said shield element is wounded in said housing.

2. The window assembly, as recited in claim 1, wherein said side edge portions of said shield element are embedded in said side rims along said running rails respectively to enhance the strength of said shield element.

3. The window assembly, as recited in claim 1, wherein said housing embedded in said top rim within said wall structure to hide said housing, wherein said opening of said housing is formed at said top rim.

4. The window assembly, as recited in claim 2, wherein said housing embedded in said top rim within said wall structure to hide said housing, wherein said opening of said housing is formed at said top rim.

5. The window assembly, as recited in claim 1, wherein said actuation unit comprises a plurality of spaced apart pulleys rotatably supported at said bottom rim and a pulling cable having a hidden portion affixing to said bottom edge portion of said shield element and a pulling portion extended to couple with said pulleys and extended out of said window frame at said interior side thereof, so that when said pulling portion of said pulling cable is pulled downwardly, said bottom edge portion of said shield element is pulled downwardly to said bottom rim through said pulleys.

6. The window assembly, as recited in claim 2, wherein said actuation unit comprises a plurality of spaced apart pulleys rotatably supported at said bottom rim and a pulling cable having a hidden portion affixing to said bottom edge portion of said shield element and a pulling portion extended to couple with said pulleys and extended out of said window frame at said interior side thereof, so that when said pulling portion of said pulling cable is pulled downwardly, said bottom edge portion of said shield element is pulled downwardly to said bottom rim through said pulleys.

7. The window assembly, as recited in claim 4, wherein said actuation unit comprises a plurality of spaced apart pulleys rotatably supported at said bottom rim and a pulling cable having a hidden portion affixing to said bottom edge portion of said shield element and a pulling portion extended to couple with said pulleys and extended out of said window frame at said interior side thereof, so that when said pulling portion of said pulling cable is pulled downwardly, said bottom edge portion of said shield element is pulled downwardly to said bottom rim through said pulleys.

8. The window assembly, as recited in claim 1, wherein said operation system further comprises two roller wheels rotatably affixed to said side edge portions of said shield element to slide along said running rails respectively for enhancing the sliding movement of said shield element.

9. The window assembly, as recited in claim 4, wherein said operation system further comprises two roller wheels rotatably affixed to said side edge portions of said shield element to slide along said running rails respectively for enhancing the sliding movement of said shield element.

10. The window assembly, as recited in claim 7, wherein said operation system further comprises two roller wheels rotatably affixed to said side edge portions of said shield element to slide along said running rails respectively for enhancing the sliding movement of said shield element.

11. The window assembly, as recited in claim 1, wherein said mounting frame further has an elongated sealing slot formed at said bottom rim to seal and receive said bottom edge portion of said shield element when said bottom edge portion of said shield element is extended to cover said window panel at said exterior side thereof.

12. The window assembly, as recited in claim 7, wherein said mounting frame further has an elongated sealing slot formed at said bottom rim to seal and receive said bottom edge portion of said shield element when said bottom edge portion of said shield element is extended to cover said window panel at said exterior side thereof.

13. The window assembly, as recited in claim 10, wherein said mounting frame further has an elongated sealing slot formed at said bottom rim to seal and receive said bottom edge portion of said shield element when said bottom edge portion of said shield element is extended to cover said window panel at said exterior side thereof.

14. The window assembly, as recited in claim 1, wherein said shield element is made of rigid and corrosion-free metal so that said shield element forms a window gate at said exterior side of said window frame to protect said window panel.

15. The window assembly, as recited in claim 13, wherein said shield element is made of rigid and corrosion-free metal so that said shield element forms a window gate at said exterior side of said window frame to protect said window panel.

16. The window assembly, as recited in claim 14, wherein said shield element is made of aluminum.

17. The window assembly, as recited in claim 15, wherein said shield element is made of aluminum.

18. The window assembly, as recited in claim 1, wherein said shield element is made of light filtering material so that said shield element forms a window shade at said exterior side of said window frame to shade said window panel.

19. The window assembly, as recited in claim 13, wherein said shield element is made of light filtering material so that said shield forms a window shade at said exterior side of said window frame to shade said window panel.

20. The window assembly, as recited in claim 4, wherein said actuation unit comprises two sliding members extended from said bottom edge portion of said shield element, free ends of said sliding members being extended at said interior side of said window frame, wherein when said two free ends of said sliding members are pulled at said interior side of said window frame to downwardly slide said bottom edge portion of said shield element, said shield element is extended to enclose said window panel.

21. The window assembly, as recited in claim 20, wherein said operation system further comprises an elongated curtain shaft detachably coupling with said free ends of said sliding members to drive said sliding members sliding towards said bottom rim, when said shield element is wounded in said housing, said curtain shaft is moved at said top rim for a curtain being supported at said interior side of said window frame.

22. The window assembly, as recited in claim 21, wherein each of said side rims has a top stopper and a bottom stopper, wherein said sliding members are upwardly slid until said sliding members are blocked at said top stoppers respectively when said shield element is wound in said housing, wherein said sliding members are downwardly slid until said sliding members are blocked at said bottom stoppers when said shield element is extended to cover said window panel.

23. The window assembly, as recited in claim 22, wherein said operation system further comprises two roller wheels rotatably affixed to said two side edge portions of said shield element to slide along said running rails respectively for enhancing the sliding movement of said shield element.

24. The window assembly, as recited in claim 23, wherein said mounting frame further has an elongated sealing slot formed at said bottom rim to seal and receive said bottom edge portion of said shield element when said bottom edge portion of said shield element is extended to cover said window panel at said exterior side thereof.

25. The window assembly, as recited in claim 24, wherein said shield element is made of rigid and corrosion-free metal so that said shield element forms a window gate at said exterior side of said window frame to protect said window panel.

26. The window assembly, as recited in claim 25, wherein said shield element is made of aluminum.

27. The window assembly, as recited in claim 24, wherein said shield element is made of light filtering material so that said shield element forms a window shade at said exterior side of said window frame to shade said window panel.
